(19) United States
(12) Patent Application Publication
(10) Pub. No.: US 2009/0115140 A1
(43) Pub. Date: May 7, 2009

(54) INVERTED FLANGE FLEX BOOT

(76) Inventor: Drew P. HENRY, Oroville, CA (US)

Correspondence Address: GROSS & ASSOCIATES, 1415 L STREET SUITE 1000, SACRAMETO, CA, 95814, US

(21) Appl. No.: 12/352,312

(22) Filed: Jan. 12, 2009

Related U.S. Application Data
(63) Continuation of application No. 11/340,909, filed on Jan. 27, 2006.
(60) Provisional application No. 60/647,912, filed on Jan. 27, 2005.

(51) Int. Cl. F16L 23/16

(52) U.S. Cl. 277/612

(57) ABSTRACT

The present invention discloses a sealing device for sealing a pipe passing through a wall. The device includes a first member and second member. The first member is substantially flexible, has an exterior surface and two axially aligned and opposed orifices, wherein the first orifice has a diameter less than the second orifice. The second member is disposed annularly on the exterior surface of the first member and the second member is operably configured to engage a first side of the wall when the sealing device is in use. The first orifice is operably configured to sealably engage a conduit such that the first orifice is accessible from a second opposing side of the wall when the sealing device is in use.

### CROSS REFERENCE TO RELATED APPLICATION

This application is a continuation application of U.S. nonprovisional application 1/340,909 filed Jan. 27, 2007 and of U.S. provisional application No. 60/647,912, filed on Jan. 27, 2005, which are both incorporated, in their entirety, herein by reference.

### BACKGROUND OF THE INVENTION

1. Field of Invention

This present invention relates to sealing devices for tubes that extend through walls and the mounting devices thereof.

2. Description of Related Art

Numerous conventional sealing devices exist that provide a means for sealing a conduit that extends through a wall or a tank. Additionally, in the underground tank environment many times an internal and external seal are required.

### SUMMARY OF INVENTION

It is the object of the present invention to overcome the drawbacks and shortcomings of conventional sealing devices. This present invention allows a sealing boot to be installed on a flange mounted on a side of a tank or wall through which a conduit penetrates and allows access to the sealing boot from an opposite side. The sealing boot of the present invention has two sealing members, a first sealing member for the flange and a second inverted sealing member for the conduit, such that the second sealing member is directed towards the conduit opening and may penetrate the tank. Additionally, the present invention provides for the securing of other protective devices used in covering underground plumbing.

In convention underground boot applications, a sealing boot is installed on the external side of the tank. And, if a double seal is required, a second sealing boot is installed on the internal side of the tank. If the conduit, which the boot seals needs to be replaced, the earth external to the tank must be removed in order to remove the external boot.

Similarly, if the application is for above ground tanks requiring conventional double boot protection, a worker would have to enter the tank to disconnect the internal boot from the conduit.

Another deficiency with conventional sealing devices is that in applications with underground conduits, the conduit requires a protective shield or guard. Current conventional sealing boots lack a mean to mount such a protective guard.

The present invention provides a sealing device for attaching to a flange on a tank wall and for sealing a conduit extending through the wall. The device includes first, second and third annular portions and a connecting portion. The first annular portion is substantially flexible and has a length, a diameter, first and second ends. The first end is operably configured to sealably engage the conduit and when in use. The connecting portion is substantially flexible and has first and second ends, the first end being connected to the second end of the first annular portion. The second annular portion is substantially flexible and coaxially aligned with the first annular portion. The second annular portion has a length, a diameter, an exterior surface, first and second ends, the first end of the second annular portion is connected to the second end of the connecting portion and the diameter of the second annular portion is greater than the diameter of the first annular portion and the conduit passes through the second annular portion when the sealing device is in use and the second end of the second annular portion is operably configured to receive a second conduit. The third annular portion is substantially flexible and includes a first side, a second side, an outer diameter, a first end being annularly disposed along the length and the exterior surface of the second annular portion and the outer diameter of the third annular portion being greater than the first and second annular portions. The third annular portion is operably configured to engage the flange on a first side of the wall such that the second side is disposed against the flange when the device is in use and the first annular portion is accessible from a second opposing side of the wall.

The present invent also provides a sealing device for sealing a pipe passing through a wall comprising a first member being flexible and having an exterior surface and two axially aligned and opposed orifices, wherein the first orifice has a diameter less than the second orifice and a second member being disposed annularly on the exterior surface of the first member and the second member being operably configured to engage a first side of the wall when the sealing device is in use. The first orifice is operably configured to sealably engage a conduit such that the first orifice is accessible from a second opposing side of the wall when the sealing device is in use.

Still further, the present invention discloses a conduit sealing device for sealing a conduit that penetrates a wall comprising: a first hollow annular portion having a diameter, an orifice, a length, first and second ends and a sealing portion, wherein the sealing portion is flexible and operably configured to seal to the conduit and the first end and a portion of the length of the first hollow annular portion penetrates the wall when the device is in use; a second hollow annular portion having a length, a flexible first end and a second end having a diameter axially aligned with and greater than the diameter of the first hollow annular portion, wherein the flexible first end of the second hollow annular portion is flexibly engaged to the second end of the first hollow annular portion; and, a mounting portion disposed annularly along the length of the second hollow annular portion, wherein the mounting portion is operably configured to removably attach device to the wall.

These and other features and advantages of this invention are described in, or are apparent from, the following detailed description of various exemplary embodiments of the devices and methods according to this invention.

### BRIEF DESCRIPTION OF THF DRAWINGS

Various exemplary embodiment of this invention will be described in detail, with reference to the following figures, wherein;

FIG. 1 is a perspective view of a quick fitting flexible boot consisting of one integrated member, according to a preferred embodiment of the present invention;

FIG. 2 is a front view of the quick fitting flexible boot of FIG. 1;

FIG. 3 is a top view of the quick fitting flexible boot of FIG. 1;

FIG. 4 is a cross-section view of taken along line 4-4 in FIG. 2 depicting the one-piece construction;

FIG. 5 is a cross-section of taken along line 4-4 in FIG. 2 depicting the installation of this present invention, according to a preferred embodiment of the present invention;

FIG. 6 is a side view of an alternative embodiment made in accordance with the present invention; and,

FIG. 7 is a cross-section view of another alternative embodiment made in accordance with the present invention shown in use.

### DETAILED DESCRIPTION OF THE PREFERRED EMBODIMENTS

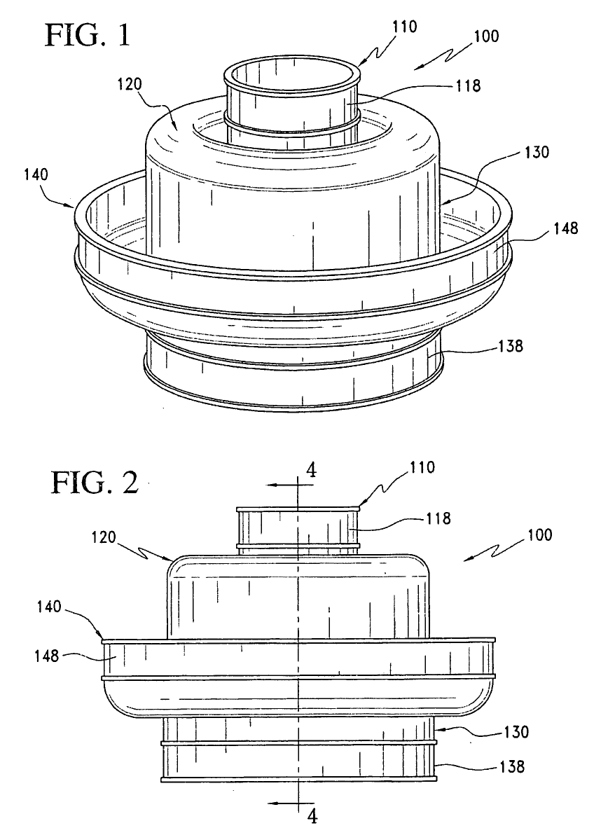

FIGS. 1 through 5 show a quick fitting flexible boot device 100, made in accordance with this invention. The device 100 is designed to be operably configured to provide a seal for flanges installed on tanks, walls, etc. in an underground environment.

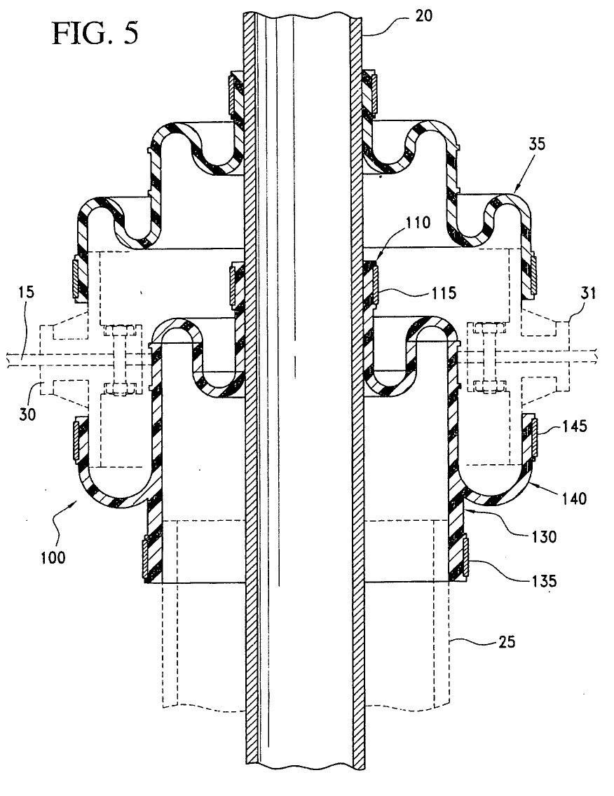

The device 100 is preferably fabricated as a one-piece construction. The device 100 includes three annular portions, 110, 130 and 140 and a connecting portion 120 as shown in FIGS. 1 through 5. The device 100 is operably configured to fit over a mounting flange 30, common to the art as shown in FIG. 5 installed on a tank or wall 15, so as to cover the mounting flange 30 and provide a seal to the mounting flange 30 and seal a conduit 20 which penetrates the flange 30. The device 100 can be use internally or externally to the tank 15. It should be appreciated that mounting flange 30 can be any known or later developed mounting flange for attaching to tanks or walls.

The device 100 is preferable constructed out of a single piece of flexible material. It is preferred that the device 100 be made out of a molded flexible pellethane compound such that annular portions 110, 130 and 140 and the connecting portion 120 are integral to each other. It should be appreciated that in other various exemplary embodiments, the device 100 can be made out of other flexible materials. Further, it should be appreciated that in other various exemplary embodiments, the annular members are not integral to each other.

Referring to FIGS. 1 through 4, the first annular portion 110 includes an interior and exterior surface 114 and 116, a clamp mounting area 118 disposed on the exterior surface 116 and a first and second end 117 and 119. The first annular portion 110 is operably configured to receive the plumbing conduit 20. In operation the conduit 20 would extend through the first annular portion 10, as shown in FIG. 5. The conduit 20 can be any type of conduit.

It should be appreciated that in other various exemplary embodiments, the first annular portion could include a stiffener encapsulated within the flexible pellethane providing the first annular portion greater rigidity. The stiffener could be but not limited to hardened plastic or steel for example.

Further, first annular portion 110 is operably configured to provide a seal around the conduit 20 used in the tank 15, thus preventing materials or fluids from the external environment leaking into the tank 15 or fluids from inside the tank 15 leaking out into the external environment. The first annular portion 11.0 further includes a diameter 113 that has a dimension that is just slightly greater then the outside diameter of the conduit 20 that will be used. When the device 100 is in use the conduit 20 is in contact with the interior surface 114 of the first annular portion 110, thus forming a seal around the conduit 20. It should be appreciated that in other various exemplary embodiments, the diameter of the first annular portion could be slightly less then the diameter of the conduit causing a natural compression of the flexible material.

The clamp mounting area 118 is operably configured to receive a circular banding device 115, shown in FIG. 5, for securing the device 110 to the conduit 20. It is preferred that the circular banding device 115 is a hose clamp used to attach first annular portion 110 to the conduit 20. It should be appreciated that in other various exemplary embodiments, other circular banding devices that are common in the art may be alternatively utilized.

As shown in FIG. 4, the first annular portion further includes a length 112. In the preferred embodiment, as shown in FIG. 5, the length 112 is such that the first annular portion 110 extends from the side of the tank wall 15 upon which the device 100 is mounted to the opposite side of the tank wall 15. This extension allows the device 100 to be disconnected from the conduit 20 form the interior of the tank wall 15. It should be appreciated that in other various exemplary embodiments, the first annular portion may not extend pass the tank wall.

The connecting portion 120 connects the first annular portion 110 to the second annular portion 130. As shown in FIG. 4, the connecting portion 120 includes a first and second end 127 and 129, wherein the first end surface 127 is connected to the second end 119 of the first annular member 110. The connecting portion 120 is integral to the first annular portion 110 and constructed out of the same flexible material.

The connecting portion 120 further includes a length, not shown, wherein the length is compressed to form an “S” shaped coil. The coil allows for all degrees of freedom of movement of the first annular portion 110. This is of interest in the underground environment where shifting of the earth around a tank is a common occurrence.

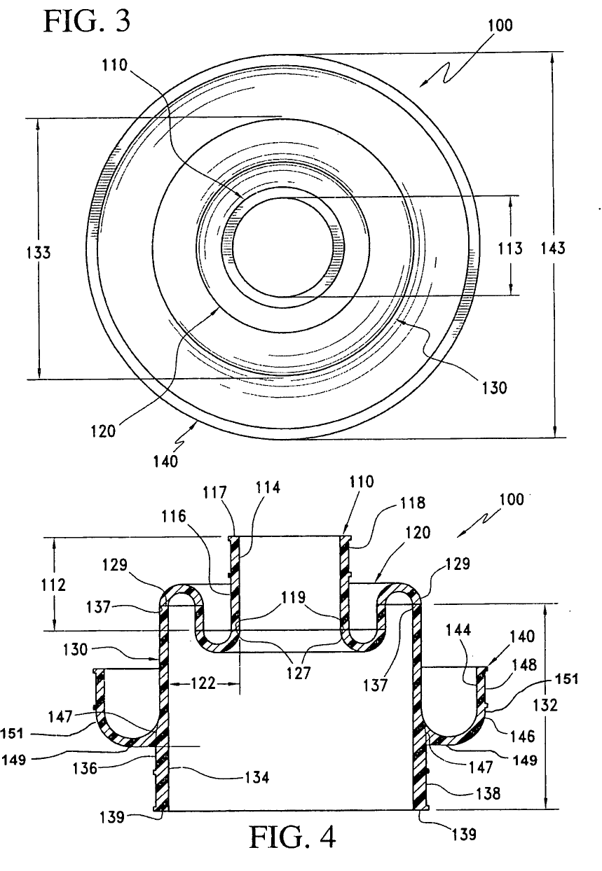

The second annular portion 130 includes a length 132, an interior and exterior surface 134 and 136, a first and second end 137 and 139, wherein the first end 137 is connected to the second end 129 of the connecting portion 120. The second annular portion 130 is integral with the connecting portion 120 and is preferably constructed of the same flexible material. The second annular portion 130 further includes a diameter 133. The diameter 133 of the second annular portion 130 has a dimension that is greater than the dimension of the diameter 113 of the first annular portion 110, as shown in FIG. 3.

The second annular portion 130 further includes a clamp mounting area 138. The second annular portion 130 is operably configured engage an underground plumbing protective conduit 25 such that the interior surface 134 is in contact with the protective conduit 25, as shown in FIG. 5. The second annular portion 130 provides a location to secure the underground plumbing protective conduit 25. It should be appreciated that in other various exemplary embodiments, the second annular member may be used in connection with other types of conduits common in the art. Additionally, it should be appreciated that in other various exemplary embodiments, the protective conduit could engage the second annular portion such that the protective conduit mates with the exterior surface of the second annular portion and a banding device is use to secure the second annular portion to the protective conduit. Still further, it should be appreciated that in other various exemplary embodiments, the second annular portion is not configured to engage the protective conduit.

It should be appreciated that in other various exemplary embodiments, the second annular portion could include a stiffener encapsulated within the flexible pellethane providing the second annular portion greater rigidity. The stiffener could be but not limited to hardened plastic or steel for example.

The third annular portion 140 is disposed on the exterior surface 136 of second annular portion 130 and is operably configured to engage the flange 30. In the preferred embodiment, the third annular portion 140 is disposed generally about the midpoint of the length 132 of the second annular portion 130. It should be appreciated that in other various exemplary embodiments, the third annular portion may be disposed any where along the length of the second annular portion. The third annular portion 140, as shown in FIG. 4, includes a first member 149, a second member 151, a first side 144 on first member 149, a second side 146 on second member 151, a clamp mounting area 148 disposed on the second side 146, a first end 147, wherein the first end 147 connects to the exterior surface 136 of the second annular portion 130, such that the first member 149 is generally perpendicular to the second annular portion 130 and the second member 151 is generally parallel to the second annular portion 130, and does not engage the second annular portion 130. Referring to FIG. 3, the third annular portion 140 further includes a diameter 143. The diameter 143 is larger than the diameter 113 of the first portion 110 and the diameter 133 of the second portion 130.

The third annular portion 140 is operably configured to cover the outside of a mounting flange 30 as shown in FIG. 5. The third annular portion 140 is operably configured to provide a seal around the flange 30 used in the tank 15 thus preventing materials or fluids from the external environment leaking into the tank 15 or fluids from inside the tank 15 leaking out into the external environment.

The clamp mounting area 148 of the third annular portion 140 148 is operably configured to receive a circular banding device 145. The third annular portion 140 is attached to the outer surface of mounting flange 30 as shown in FIG. 5, via the circular banding device 145. It is preferred that a hose clamp be used to attach the third annular portion 140 to mounting flange 30. It should be appreciated that in other various exemplary embodiments, other banding devices common in the art may be used to secure the third annular portion to the flange 30.

In many underground tanks with a conduit penetrating the tank wall, a requirement exists to double seal the conduit. A sealing boot must be installed on the interior as well as the exterior of the tank. In common practice, one conventional flexible sealing boot 35, as shown in FIG. 5, in connected to a second flange 31 and the conduit 20 located on the internal side of the tank. Normally, a second conventional sealing boot, not shown, is installed on the external side of the tank 15. With this conventional arrangement, to disconnect conduit 20 from the conventional sealing boot external to the tank 15, the earth outside of the tank 15 must be removed. The device 100 of the present invention allows for the removal of the conduit 20 without having to dig out the earth outside of the tank 15.

The excavation of earthen material is a problem because of the extra man-hours and costs required to complete the excavating. The device 100 solves this problem. The device 100 is mounted external to the tank 15 and connects to the conduit 20 via the first annular portion 110, such that the first annular portion 110 is accessible from the interior of the tank 15. This advantage allows the device 100 to be disconnected from the conduit 20 without digging the ground on the exterior of the tank 15.

Further, when the conventional sealing boot is installed on the exterior of the tank 15, not shown, the conventional sealing boot does not provide a location to mount the underground rock guards 25 as shown in FIG. 5. The use of the underground rock guards 25 are required by most state environmental laws in the application of underground hazardous material tanks. The device 100 provides a convenient location on the second annular portion 130 to mount the under ground rock guard 25.

Additionally, for applications where a boot is required to seal a conduit on the interior of a wall, (e.g. an above ground tank) the device 100 may be installed on the interior of the wall allowing access from the exterior of the wall. This is useful just to ease accessibility and in hazardous applications, such as for example a tank that stores toxic substances and would require extensive fumigation prior to entry.

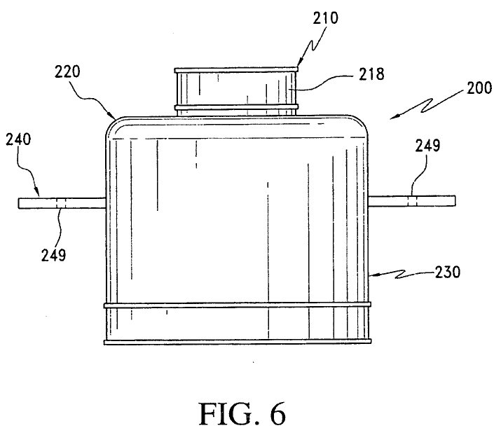

Referring now to FIG. 6, which is a side view of a device 200, presents an alternative embodiment of the device 100. The device 200 incorporates all the characteristics of the device 100, specifically in that device 200 comprises a first annular portion 210, a second annular portion 230, a third annular portion 240 and a connecting portion 220. A difference in device 200 is that the third annular portion 240 does not include a clamp mounting area like device 100. The third annular portion 240 includes a plurality of mounting orifices 249. Further the third annular portion 240 is operably configured to engage a flange between the flange and a tank wall, not shown in FIG. 6,

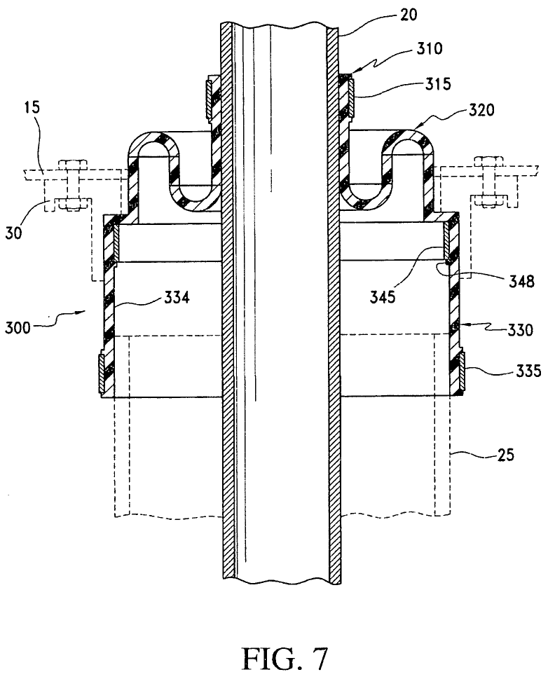

FIG. 7 is a cross-sectional view of device 300, which is another alternative embodiment made in accordance with this invention. The device 300 incorporates all the characteristics of the device 100, specifically in that the device 300 comprises a first annular portion 310, a second annular portion 330, a connecting portion 320, second annular portion interior and exterior surfaces 334 and 336 and a clamp mounting area 348. The device 300 differs from device 100 in that the device 300 does not have a third annular portion. Further, the clamp mounting area 348 is disposed on the interior surface 334 rather than the exterior surface 336 as in device 100. The device 300 further includes a clamp 335, which is similar to clamp 135 in FIG. 5 and a clamp 345, however, unlike clamp 145 used for device 100, clamp 345 is an expansion clamp, such that clamp 345 exerts force outwardly vice inwardly.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A sealing device for attaching to a flange on a tank wall and for sealing a first conduit extending through the wall and for sealing a second conduit that does not extend through the wall comprising:
a first annular portion being substantially flexible and having a length, a diameter and first and second ends, wherein the conduit extends through the first annular portion when in use and the first end being operably configured to sealably engage the first conduit;
a connecting portion being substantially flexible and having first and second ends, the first end being connected to the second end of the first annular portion;
a second annular portion being substantially flexible and coaxially aligned with the first annular portion and having a length, a diameter, an exterior surface, first and second ends, the first end of the second annular portion being connected to the second end of the connecting portion and the diameter of the second annular portion being greater than the diameter of the first annular portion and the conduit passes through the second annular portion when the sealing device is in use, and wherein the second end of the second annular portion is operably configured to sealably engage the second conduit, when the device is in use; and,
a third annular portion being substantially flexible and having a first side, a second side, an outer diameter, a first end being annularly disposed along the length of the exterior surface of the second annular portion and the outer diameter of the third annular portion being greater than the first and second annular portions,
wherein the third annular portion is operably configured to engage the flange disposed on a first side of the wall such that the second side of the third annular portion is disposed against the flange when the device is in use and the first annular portion is accessible from a second opposing side of the wall when the sealing device is in use.

2. A sealing device, as recited in claim 1, wherein the first annular portion further includes an exterior surface and a clamp mounting area disposed on the exterior surface.

3. A sealing device, as recited in claim 1, wherein the length of the first annular portion penetrates the tank wall when the device is in use.

4. A sealing device, as recited in claim 1, wherein the third annular portion is disposed generally at the midpoint of the length of the second annular portion.

5. A sealing device, as recited in claim 1, wherein the first, second and third annular portions and the connecting portion are integral to each other.

6. A sealing device, as recited in claim 1, wherein the first member of the third annular portion is disposed generally perpendicular to the exterior surface of the second annular portion and the second member of the third annular portion is oriented generally parallel to the exterior surface of the second annular portion such that the second side does not engage the second annular portion.

7. A sealing device, as recited in claim 1, wherein the third annular portion further includes a mounting surface disposed on the second side.

8. A sealing device for sealing a first pipe passing through a wall and a second pipe that does not pass through the wall comprising:
a first member being flexible and having an exterior surface and two axially aligned and opposed orifices, wherein the first orifice has a diameter less than the second orifice; and,
a second member being disposed annularly on the exterior surface of the first member, and the second member being operably configured to engage a first side of the wall when the sealing device is in use,
wherein the first orifice is operably configured to sealably engage the first pipe such that the first orifice is accessible from a second opposing side of the wall when the sealing device is in use, and the second orifice is operably configure to sealably engage the second pipe, when the device is in use.

9. A sealing device, as recited in claim 8, wherein the first orifice of the first member extends through the wall when the sealing device is in use.

10. A sealing device, as recited in claim 8, wherein the second member further includes a first end and the first end is disposed against the first member.

11. A sealing device, as recited in claim 8, wherein the second member has a first and second portion, the first portion is disposed annularly on the exterior surface of the first member and the second portion of the second member further includes an exterior surface and a clamp mounting area dispose on the exterior surface.

12. A sealing device, as recited in claim 8, wherein the first member further includes a clamp mounting area generally disposed adjacent to the second orifice on the exterior surface and the second orifice is operably configured to engage a second conduit.

13. A sealing device, as recited in claim 8, wherein the second member is integral to the first member and forms a portion thereof.

14. A sealing device, as recited in claim 8, wherein the second member is dispose adjacent to the second orifice of the first member.

15. A conduit sealing device for sealing a first conduit that penetrates a wall and for sealing a second conduit that does not penetrate the wall comprising:
a first hollow annular portion having a diameter, an orifice, a length, first and second ends and a sealing portion, wherein the sealing portion is flexible and operably configured to seal to the first conduit and the first end and a portion of the length of the first hollow annular portion penetrates the wall when the device is in use;
a second hollow annular portion having a length, a flexible first end and a second end having a diameter axially aligned with and greater than the diameter of the first hollow annular portion, wherein the flexible first end of the second hollow annular portion is flexibly engaged to the second end of the first hollow annular portion, and the second end is operably configure to sealably engage the second conduit, when the device is in use; and,
a mounting portion disposed annularly along the length of the second hollow annular portion, wherein the mounting portion is operably configured to removably attach the device to the wall.

16. A conduit sealing device, as recited in claim 15, wherein the first hollow annular portion, the second hollow annular portion and the mounting portion are integral.

17. A conduit sealing device, as recited in claim 15, wherein the second hollow annular portion further includes an exterior surface and the mounting portion is disposed on the exterior surface.

18. A conduit sealing device, as recited in claim 15, wherein the mounting portion is disposed on the second hollow annular portion generally near the second end.

19. A conduit sealing device, as recited in claim 15, wherein the mounting portion further includes a flexible first member and a flexible second member, wherein the flexible second member is integral to the flexible first member at about a 90 degree angle to the flexible first member, such that the flexible first member is disposed on the second hollow annular portion such that the flexible second member is not in contact with the second hollow annular portion and oriented toward the flexible first end of the second hollow annular portion and is substantially parallel to the axis of the first hollow annular portion.

20. A conduit sealing device, as recited in claim 15, wherein the second end of the second hollow annular portion is operably configured to receive a second conduit.
